(19) United States
(12) Patent Application Publication
(10) Pub. No.: US 2025/0132574 A1
(43) Pub. Date: Apr. 24, 2025

(54) SUPERCAPACITOR AND METHOD OF MANAGING ENERGY THEREOF

(71) Applicant: CAPYBARA ENERGY LLC, Seabrook, NH (US)

(72) Inventors: Matthew Millard, Seabrook, NH (US); Daniel Danila, Sharon, MA (US)

(21) Appl. No.: 18/922,310

(22) Filed: Oct. 21, 2024

Related U.S. Application Data
(60) Provisional application No. 63/591,742, filed on Oct. 19, 2023.

(51) Int. Cl. H02J 7/00; H02J 7/34

(52) U.S. Cl. CPC H02J 7/0013; H02J 7/007182; H02J 7/345; H02J 2207/50

(57) ABSTRACT

A method of managing energy for a supercapacitor includes charging a plurality of cells of an energy storage module of a supercapacitor during a charge cycle. The energy storage module includes a plurality of strings connected to each other in a parallel configuration. Each string of the plurality of strings includes a plurality of stacks connected to each other in a series configuration. Each stack of the plurality of stacks includes a quantity of cells of the plurality of cells. The method includes, during the charge cycle, measuring a voltage of a cell of the plurality of cells. The method includes, during the charge cycle, and based at least in part on the measured voltage, increasing a quantity of the plurality of strings by decreasing a quantity of the stacks of at least one string of the plurality of strings.

### CROSS-REFERENCE TO RELATED APPLICATION

This application claims the benefit of U.S. Provisional Patent Application No. 63/591,742, filed Oct. 19, 2023, which is incorporated herein by reference.

### FIELD

This disclosure relates generally to energy management, and more particularly to supercapacitors and methods of managing energy thereof.

### BACKGROUND

In the field of large-scale energy storage and management, Energy Management Systems (“EMS”) help to optimize the performance, safety, and efficiency of energy storage devices, such as supercapacitors, batteries, and other energy storage technologies. EMSs have applications in fields such as renewable energy integration, electric vehicles, grid energy storage, industrial and commercial energy management, aerospace, and defense.

### SUMMARY

The subject matter of the present application has been developed in response to the present state of the art, and in particular, in response to the shortcomings of energy storage systems that have not yet been fully solved by currently available techniques. Accordingly, the subject matter of the present application has been developed to provide supercapacitors and methods of managing energy for energy storage systems that overcome at least some shortcomings of prior art techniques.

The following is a non-exhaustive list of examples, which may or may not be claimed, of the subject matter, disclosed herein.

The following portion of this paragraph delineates example 1 of the subject matter, disclosed herein. According to example 1, a method of managing energy for a supercapacitor includes charging a plurality of cells of an energy storage module of a supercapacitor during a charge cycle. The energy storage module includes a plurality of strings connected to each other in a parallel configuration. Each string of the plurality of strings includes a plurality of stacks connected to each other in a series configuration. Each stack of the plurality of stacks includes a quantity of cells of the plurality of cells. The method includes, during the charge cycle, measuring a voltage of a cell of the plurality of cells. The method includes, during the charge cycle, and based at least in part on the measured voltage, increasing a quantity of the plurality of strings by decreasing a quantity of the stacks of at least one string of the plurality of strings.

The following portion of this paragraph delineates example 2 of the subject matter, disclosed herein. According to example 2, which encompasses example 1, above, the method includes transmitting the measured voltage to a supervisory control and data acquisition system. Increasing the quantity of the plurality of strings is further based at least in part on input received from the supervisory control and data acquisition system.

The following portion of this paragraph delineates example 3 of the subject matter, disclosed herein. According to example 3, which encompasses example 1 or 2, above, increasing the quantity of the plurality of strings includes creating one or more new strings by reconfiguring at least one stack of the plurality of stacks from each string into the one or more new strings.

The following portion of this paragraph delineates example 4 of the subject matter, disclosed herein. According to example 4, which encompasses any one of examples 1-3, above, the voltage includes a first measured voltage. The method includes, during the charge cycle, measuring a second measured voltage. The second measured voltage is a voltage of the cell, a voltage of an additional cell of the plurality of cells, or a combination thereof. The method includes, based at least in part on the second measured voltage, further increasing the quantity of the plurality of strings by further decreasing the quantity of the plurality of stacks of at least one string of the plurality of strings.

The following portion of this paragraph delineates example 5 of the subject matter, disclosed herein. According to example 5, which encompasses any one of examples 1-4, above, the method includes, during the charge cycle, measuring a third measured voltage. The third measured voltage is an additional voltage of the cell or of an additional cell of the plurality of cells. The method includes determining whether the third measured voltage is greater than or equal to a threshold voltage. The method includes, in response to determining that the third measured voltage is greater than or equal to the threshold voltage, terminating the charge cycle.

The following portion of this paragraph delineates example 6 of the subject matter, disclosed herein. According to example 6, which encompasses any one of examples 1-5, above, the threshold voltage is greater than the second measured voltage, and the second measured voltage is greater than the first measured voltage.

The following portion of this paragraph delineates example 7 of the subject matter, disclosed herein. According to example 7, which encompasses any one of examples 1-6, above, increasing the quantity of the plurality of strings based at least in part on the measured voltage includes increasing the quantity of the plurality of strings in response to determining that the measured voltage is greater than a pre-determined voltage

The following portion of this paragraph delineates example 8 of the subject matter, disclosed herein. According to example 8, which encompasses any one of examples 1-7, above, the method includes determining, based at least in part on the measured voltage, an input voltage of the energy storage module. The method includes determining, based at least in part on the input voltage of the energy storage module, a ratio between the input voltage and an output voltage of the energy storage module. The method includes increasing the quantity of the plurality of strings further based at least in part on whether the ratio is outside of a range.

The following portion of this paragraph delineates example 9 of the subject matter, disclosed herein. According to example 9, which encompasses any one of examples 1-8, above, the quantity of the plurality of strings is increased in response to the ratio being outside of the range.

The following portion of this paragraph delineates example 10 of the subject matter, disclosed herein. According to example 10, which encompasses any one of examples 1-9, above, the range is between, and inclusive of, 0.1 and 10.0.

The following portion of this paragraph delineates example 11 of the subject matter, disclosed herein. According to example 11, which encompasses any one of examples 1-10, above, the cell of the plurality of cells is a first cell. The method further includes determining whether the measured voltage is at least one of greater than an upper threshold voltage or less than a lower threshold voltage. The method includes, in response to determining that the measured voltage is at least one of greater than the upper threshold voltage or less than the lower threshold voltage, calculating a deviation between the measured voltage and at least one of the upper threshold voltage or the lower threshold voltage. The method includes determining whether the deviation is greater than a threshold deviation. The method includes in response to determining that the deviation is greater than the threshold deviation, actuating a circuit to perform at least one of the following: a transfer of current from the first cell to a second cell of the plurality of cells in response to the measured voltage being greater than the upper threshold voltage; and a transfer of current from the second cell to the first cell in response to the measured voltage being less than the lower threshold voltage.

The following portion of this paragraph delineates example 12 of the subject matter, disclosed herein. According to example 12, which encompasses any one of examples 1-11, above, the upper threshold voltage is not less than 1.2 Volts (“V”) and not greater than 3 V.

The following portion of this paragraph delineates example 13 of the subject matter, disclosed herein. According to example 13, which encompasses any one of examples 1-12, above, the lower threshold voltage is not less than 0.05 Volts (“V”) and not greater than 1.2 V.

The following portion of this paragraph delineates example 14 of the subject matter, disclosed herein. According to example 14, which encompasses any one of examples 1-13, above, increasing the quantity the plurality of strings includes maintaining a quantity of the plurality of cells in the energy storage module.

The following portion of this paragraph delineates example 15 of the subject matter, disclosed herein. According to example 15, a supercapacitor includes an energy storage module. The energy storage module includes a plurality of strings connected to each other in a parallel configuration and a plurality of cells. Each string of the plurality of strings includes a plurality of stacks connected to each other in a series configuration. Each stack of the plurality of stacks includes a quantity of cells of the plurality of cells. The supercapacitor includes a circuit configured to charge the plurality of cells during a charge cycle. The supercapacitor includes a voltage sensor configured to measure a voltage of a cell of the plurality of cells during the charge cycle. The supercapacitor includes a switch and a processor configured to, during the charge cycle and based at least in part on the measured voltage, actuate the switch to increase a quantity of the plurality of strings of the parallel configuration by decreasing a quantity of the plurality of stacks of at least one string of the plurality of strings.

The following portion of this paragraph delineates example 16 of the subject matter, disclosed herein. According to example 16, which encompasses any one of example 15, above, the switch includes a relay switch configured to control a connection between a first string of the plurality of strings and a second string of the plurality of strings.

The following portion of this paragraph delineates example 17 of the subject matter, disclosed herein. According to example 17, which encompasses any one of examples 15-16, above, the relay switch includes a first relay switch and the supercapacitor further includes a second relay switch configured to control a connection between a first-string stack of the first string and a second-string stack of the second string.

The following portion of this paragraph delineates example 18 of the subject matter, disclosed herein. According to example 18, a method of managing energy for a supercapacitor includes discharging a plurality of cells of an energy storage module of a supercapacitor during a discharge cycle. The energy storage module includes a plurality of strings connected to each other in a parallel configuration. Each string of the plurality of strings includes a plurality of stacks connected to each other in a series configuration. Each stack of the plurality of stacks includes a quantity of cells of the plurality of cells. The method includes, during the discharge cycle, measuring a voltage of a cell of the plurality of cells. The method includes, during the discharge cycle, and based at least in part on the measured voltage, decreasing a quantity of the plurality of strings by increasing a quantity of the plurality of stacks of at least one string of the plurality of strings.

The following portion of this paragraph delineates example 19 of the subject matter, disclosed herein. According to example 19, which encompasses example 18, above, the voltage is a first measured voltage. The method further includes, during the discharge cycle, measuring a second measured voltage of the cell or of an additional cell of the plurality of cells. The method includes determining whether the second measured voltage is less than or equal to a threshold voltage, and, in response to determining that the second measured voltage is less than or equal to the threshold voltage, terminating the discharge cycle.

The following portion of this paragraph delineates example 20 of the subject matter, disclosed herein. According to example 20, which encompasses any one of examples 18-19, above, decreasing the quantity of the plurality of strings includes halving the quantity of the plurality of strings and increasing the quantity of the plurality of stacks of each string of the plurality of strings comprises doubling the quantity of the plurality of stacks.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a schematic diagram of an energy storage system, according to one or more examples of the present disclosure;

FIG. 2 is a schematic diagram of an energy storage system with cell balancing apparatuses, according to one or more examples of the present disclosure;

FIG. 3 is a schematic diagram of a cell balancing apparatus of an energy storage system, according to one or more examples of the present disclosure;

FIG. 4 is schematic flow chart of a method of cell balancing, according to one or more examples of the present disclosure;

FIG. 5 is a schematic flow chart of a method of cell balancing by transferring current between cells, according to one or more examples of the present disclosure;

FIGS. 6A-D are schematic diagrams illustrating steps of a method of managing energy for an energy storage system, according to one or more examples of the present disclosure;

FIG. 7 is a schematic flow chart of managing energy for an energy storage system, according to one or more examples of the present disclosure; and

FIG. 8 is a schematic flow chart of managing energy for an energy storage system during a discharge cycle, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Examples of the present disclosure include systems configured to control, monitor, and/or help to maximize the utilization of an energy storage device, such as a supercapacitor. Examples of the present disclosure include systems employing algorithms and control strategies that help to optimize an energy storage system's performance and help to ensure efficient charging and discharging processes.

Examples of the present disclosure include large-format supercapacitors, such as large-format, aqueous supercapacitors. In some examples, such supercapacitors are configured to help promote safe storage and operation, with or without active cell balancing.

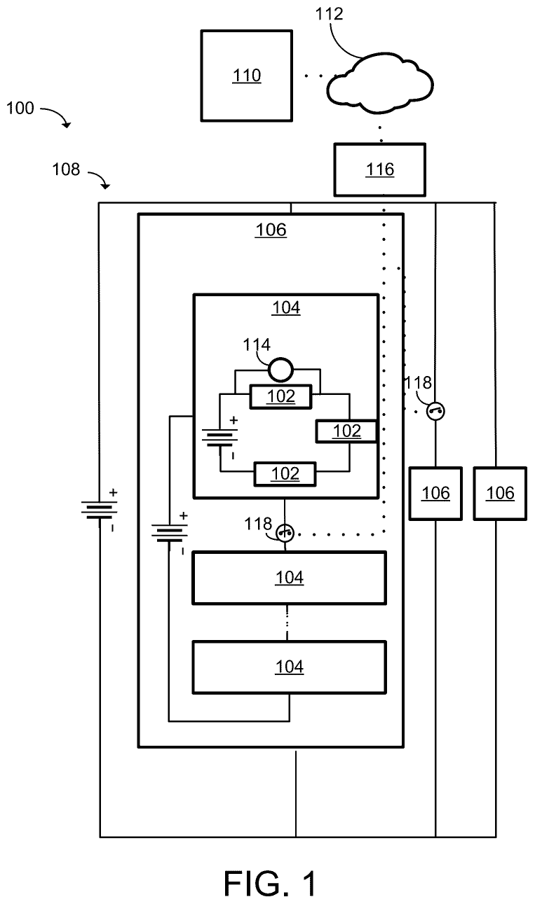

Referring to FIGS. 1-3, examples of the present disclosure include an energy storage system 100, such as a supercapacitor. In some examples, the energy storage system 100 includes a large-format supercapacitor, an aqueous supercapacitor, a carbon-based aqueous supercapacitor, and/or a combination thereof. In some examples, the energy storage system 100 is a system for large-scale energy storage are disclosed herein. In some examples, large-scale energy storage can be defined as storage of about or greater than 1 kilowatt for 1 hour (i.e., 1 kilowatt-hour (kWh)).

In some examples, the energy storage system 100 includes energy storage cells 102, stacks 104 of energy storage cells 102, strings 106 of stacks 104, modules 108 of strings 106, sensors 114, switches 118, a processor 116, a distribution component 120, a temperature control apparatus 122, a cell balancing apparatus 124, a power converter 126, an interconnect 128, and/or any combination thereof. In some examples, the processor 116 is configured to communicate with a remote client 110 over a network 112.

In some examples, the processor 116 includes a processor of an energy management system (“EMS”) for the energy storage system 100. In various examples, the processor 116 is configured to control DC distribution via a connection with the distribution component 120 to adjust configurations of the module 108, charging rates, discharging rates, and/or any combination thereof during a charge and/or discharge cycle of the module 108. In some examples, the processor 116 also controls a connection with the power converter 126.

In some examples, the cells 102 are units of energy storage for the energy storage system 100. In some examples, the cells 102 are re-chargeable energy storage devices. In some examples, a cell 102 includes an electrode. In some examples, the electrode includes a carbon-based material, such as activated carbon, carbon nanotubes, graphene, or a combination thereof. In some examples, a cell 102 includes an electrolyte, such as an aqueous electrolyte or organic electrolyte, formulated to allow ions to move between the electrodes. In some examples, a cell 102 also includes a separator configured to separate the electrodes while allowing ions to pass through. A separator includes, in various examples, a porous membrane. In some examples, the cells 102 include a large format capacitor cell. In some examples, at least one cell 102 has a dimension of 15 centimeters (cm) by 15 cm or larger.

In some examples, the energy storage system 100 includes one or more stacks 104 of cells. In various examples, a stack 104 is a group of cells 102. As shown in FIG. 1, in some examples, cells 102 are connected in series to form a stack 104. However, examples of the present disclosure are not so limited. In some examples, cells 102 are connected to other cells 102 in parallel within a stack 104. In some examples, a stack 104 includes a group of cells 102 connected in series to help meet higher voltage needs. In other examples, a stack 104 includes a group of cells 102 connected in parallel to help meet higher current and/or lower voltage needs. In some examples, the stack 104 is configured to operate as a standalone unit for particular applications.

In some examples, the cells 102 are connected to the distribution component 120. In some examples, a cell 102 is connected to the distribution component 120 via inter-cell current collectors, such as bipolar plates. In some examples, a cell 102 is connected outside of the stack 104 via tabs.

In some examples, the energy storage system 100 includes one or more strings 106 of stacks 104. In various examples, a string 106 is a group of stacks 104. In some examples, as shown in FIG. 1, a string 106 includes multiple stacks 104 connected to each other in series. In some examples, a string 106 includes multiple stacks 104 connected to each other in parallel.

In some examples, the energy storage system 100 includes one or more modules 108 of strings 106. In various examples, a module 108 is a group of strings 106. In some examples, the module 108 is a standalone unit of the energy storage system 100. Although FIG. 1 shows only one module 108, examples of the present disclosure also include energy storage systems 100 with multiple modules 108. In some examples, as shown in FIG. 1, the module 108 includes multiple strings 106 connected to each other in parallel. Examples of the present disclosure also include modules 108 with multiple strings 106 connected to each other in a series configuration.

Referring to FIG. 1, in some examples, the energy storage system 100 includes one or more sensors 114. These sensors 114 include, in some examples, voltage sensors, current sensors, temperature sensors, impedance sensors, and/or any combination thereof. In some examples, the sensors 114 are configured to collect data from individual cells 102 and/or modules 108 within the energy storage system 100. As shown in FIG. 1, in some examples, a sensor 114 is placed to monitor an individual cell 102 within the energy storage system 100. In some examples, the sensor 114 is configured to measure a voltage drop across a cell 102. Although FIG. 1 shows only one sensor 114 placed to measure a parameter of a single cell 102, examples of the present disclosure are not so limited. In some examples, the energy storage system 100 includes multiple sensors 114 placed to measure parameters of multiple different cells 102, such as different cells 102 from the same stack 104 or cells 102 of different stacks 104, strings 106, and/or modules 108.

In some examples, the sensors 114 are configured to continuously monitor a parameter of a cell 102. In some examples, the sensors 114 are communicatively coupled to the processor 116 and configured to relay measurements to the processor 116. In various examples, the sensors 114 provide real-time data to the processor 116. In some examples, the processor 116 and/or the sensors 114 are configured to store measurements for the parameters in memory. In some examples, the sensors 114 include at least one of: a voltage sensor, a digital voltage sensor, a Hall Effect sensor, an integrated circuit voltage sensor, a voltmeter, a current sensor, a shunt resistor, a Rogowski Coil, a current transformer, an integrated circuit current sensor, a temperature sensor, a thermistor, a resistance temperature detector, an infrared sensor, an integrated circuit temperature sensor, or any combination thereof.

In some examples, the energy storage system 100 is configured to actively balance the voltage and energy levels of individual cells 102 and/or modules 108 within an energy storage system 100. This helps to reduce the likelihood of overcharging of some cells 102 while allowing others to reach their maximum capacity during charging and discharging cycles. In some examples, the energy storage system 100 is configured to passively balance the voltage and energy levels of individual cells 102 and/or modules 108 within the energy storage system 100. In some examples, the energy storage system 100 includes a resistor into which current from a cell 102 is directed to help lower a voltage of that cell 102.

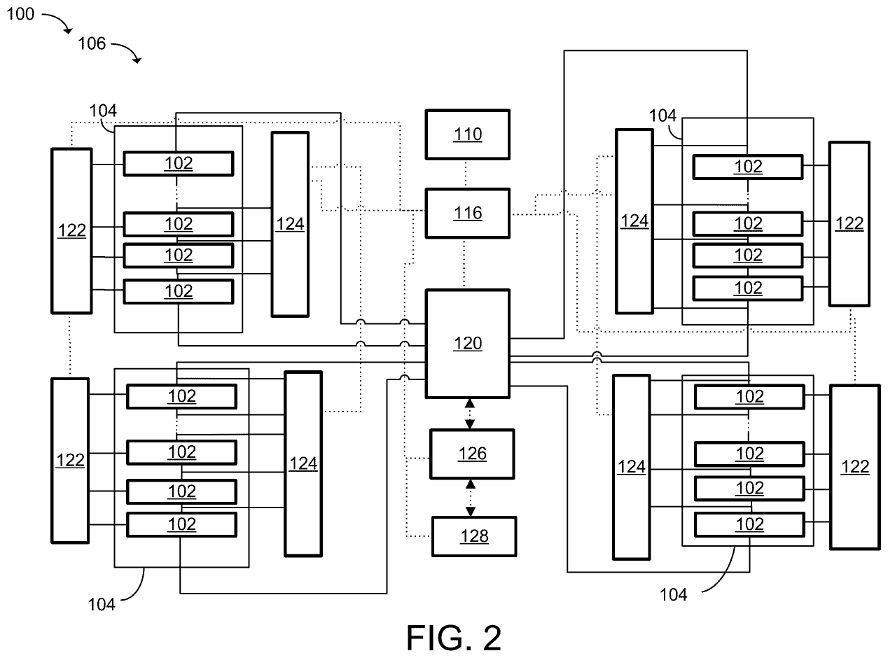

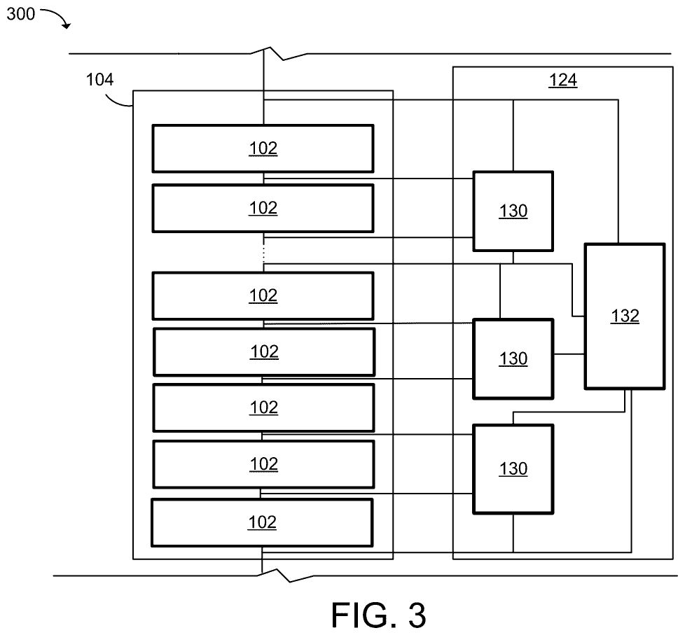

Referring to FIGS. 2 and 3, in some examples, the energy storage system 100 includes a cell balancing apparatus 124. In some examples, the energy storage system 100 includes a cell balancing apparatus 124 for each stack 104 of the energy storage system 100. In other examples, a cell balancing apparatus 124 serves multiple strings 106 and/or multiple modules 108 of the energy storage system 100. In some examples, an energy storage system 100 includes not less than 3 and not greater than 10 cell balancing apparatuses 124. In some examples, at least one cell 102 is electrically connected to the cell balancing apparatus 124. In some examples, the cell balancing apparatus 124 is in communication with the processor 116. In some examples, the cell balancing apparatus 124 is powered directly from the stack 104. In other examples, the cell balancing apparatus 124 is powered by an auxiliary source. Referring to FIG. 3, in some examples, the cell balancing apparatus 124 includes sensors 114.

In some examples, the cell balancing apparatus 124 includes one or more energy transfer boards. In some examples, the cell balancing apparatus 124 is connected to and/or communicates with cell balancing circuitry, such as switches 118, voltage sensors 114, transistors, and/or other power electronics components to control flow of current between cells 102.

Referring to FIG. 3, examples of the present disclosure include a cell balancing system 300. In some examples, the cell balancing system 300 includes a cell balancing apparatus 124 for balancing cells 102 of a stack 104. In some examples, the cell balancing system 300 includes dedicated balancing circuitry configured to be actuated (e.g., by the cell balancing apparatus 124) to transfer energy between cells 102. The circuitry includes, in various examples, switches, resistors, capacitors, or any combination thereof. In some examples, the cell balancing system 300 includes dedicated cell balancing circuitry for each cell 102. The cell balancing circuitry, in some examples, helps to redistribute energy and/or equalize voltage levels of individual cells 102. In some examples, the cell balancing circuitry is actuated by the processor 116.

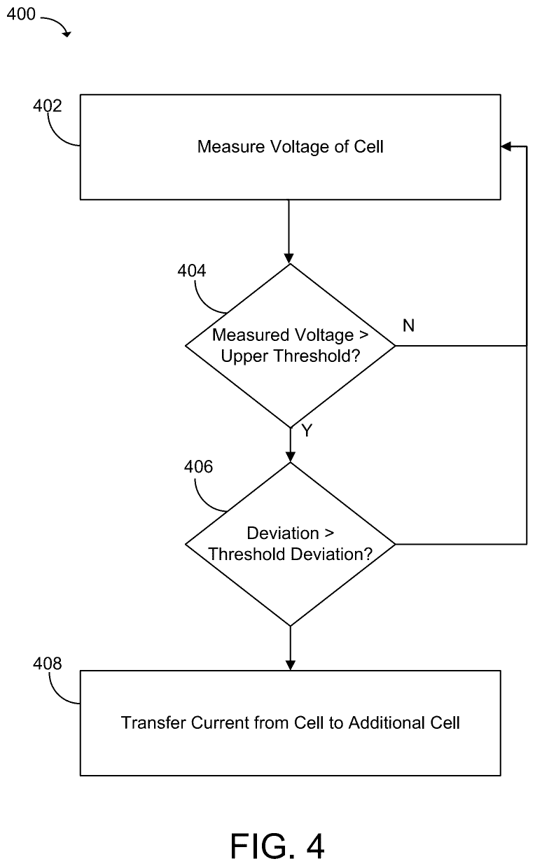

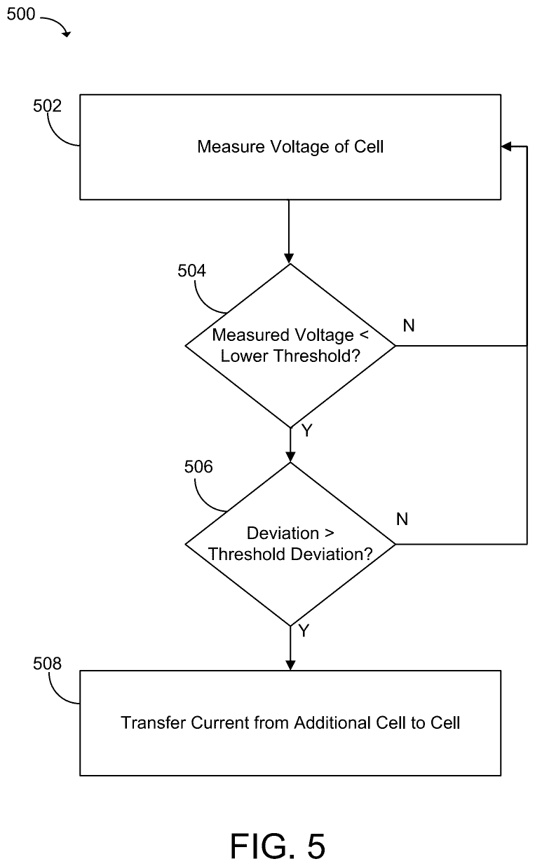

Referring to FIGS. 4 and 5, examples of the present disclosure include methods 400, 500 for balancing cells 102 by discharging a cell 102 into another cell 102. In some examples, the operations of the methods 400, 500 are performed by the cell balancing apparatus 124 in communication with sensors 114. In some examples, operations of the methods 400, 500 are performed by another processor (e.g., processor 116) of the energy storage system 100 in communication with sensors 114. In some examples, the cell balancing apparatus 124 includes a memory and a processor configured to execute instructions stored on the memory.

Referring to FIG. 4, in some examples, the method 400 includes a step 402 of measuring the voltage of a cell 102. In some examples, the sensor 114 takes a voltage measurement during a charge cycle and/or a discharge cycle of the cell 102. In some examples, the method 400 determines, at step 404, whether measured voltage is greater than an upper threshold voltage. As used herein, the terms “charge cycle” and or “discharge cycle” include any period of time over which a component of the energy storage system 100, such as a cell 102, is charged (e.g., supplied with current) or discharged.

In some examples, the upper threshold voltage is not less than 1.2 Volts (“V”) and not greater than 3 V. In some examples, the upper threshold voltage is not less than 1.7 V and not greater that 2.2 V. In some examples, the upper threshold voltage is approximately 2.2 V. In some examples, the upper threshold voltage is approximately 1.6V. In some examples, the upper threshold voltage is a predetermined value stored in memory. In various examples, the cell balancing apparatus 124 receives the upper threshold voltage from a remote client 110, such as a remote user and/or a supervisory control and data acquisition system (“SCADA”).

If the measured voltage from step 402 is not greater than the upper threshold, the charge and/or discharge cycle continues, and the sensors 114 continue to read data from the cell 102. If the measured voltage is greater than the upper threshold, the method 400 continues to step 406 and determines whether the deviation is greater than a threshold deviation. In some examples, the method 400 includes calculating the deviation. The deviation is the difference between the measured voltage of step 402 and the upper threshold voltage. In some examples, the threshold deviation is 0. In other examples, the threshold deviation is greater than 0.

In one example, a sensor 114 measures, at step 402, a voltage of 3.2 V across a cell 102. The sensor 114 relays the measured voltage to the cell balancing apparatus 124. In such an example, the cell balancing apparatus 124 then determines, at step 404, that the measured voltage of 3.2 V is greater than the upper threshold voltage of 3.0 V. If the difference between the measured voltage and the upper threshold voltage is less than a threshold deviation, no adjustments are made, and the sensor 114 continues to monitor the voltage of the cell 102. In some examples, the threshold deviation is 0.1 V, meaning that the difference between the measured voltage and the upper threshold voltage is greater than the threshold deviation.

The method 400 includes a step 408 of transferring current from that cell 102 to an additional cell 102, if the deviation is greater than the threshold deviation. In some examples, the cell balancing apparatus 124 actuates a circuit component (e.g., a switch 118) to transfer current from one cell 102 to an additional cell 102 in the same stack 104. In some examples, transferring current to a cell 102 includes transferring a charge to that cell 102. In some examples, the additional cell 102 is a cell 102 with a measured voltage that is less than the voltage measured in step 402 for the cell 102. In some examples, the additional cell 102 is a cell 102 with a measured voltage less than a lower threshold voltage and/or a measured voltage less than the upper threshold voltage. In various examples, the method 400 includes actuating a sensor 114 to measure a voltage of additional cells 102 in response to determining, at step 406, that the deviation is greater than the threshold deviation. In one or more examples, the method 400 includes creating pairs of cells 102 for energy transfer based on measured voltages.

In some examples, the method 400 includes a step, in addition and/or alternative to step 408, of switching a configuration of a connection between cells 102 in response to the deviation being greater than the threshold deviation. For example, the method 400 includes actuating the circuitry (e.g., via a switch 118) to change the connection between cells 102 from a series configuration to a parallel configuration in response to the deviation being greater than a threshold deviation. In one or more examples, the method includes switching a configuration of a connection between stacks 104 and/or strings 106 of cells 102 in response to the deviation being greater than a threshold deviation. In some examples, the method 400 includes a step of, in response to the deviation being greater than the threshold deviation, increasing a quantity of strings 106 by decreasing the quantity of stacks 104 in each string.

In some examples, the method 400 includes returning to step 402 of measuring the voltage, and the sensor 114 continues to monitor the voltage until the cell balancing apparatus 124 determines that the measured voltage is less than the upper threshold. In some examples, in response to the measured voltage being less than the upper threshold, the cell balancing apparatus 124 actuates the circuitry to cease transferring current from the cell 102 to the additional cell 102.

Referring to FIG. 5, in some examples, the method 500 includes a step 502 of measuring the voltage of a cell 102. In some examples, the sensor 114 takes a voltage measurement during a charge cycle and/or a discharge cycle of the cell 102. In some examples, the method 500 includes a step 504 of determining whether measured voltage is less than a lower threshold voltage. In some examples, the lower threshold voltage is not less than 0.05 V and not greater than 1.2 V. In some examples, the lower threshold voltage is approximately 0.1 V. In some examples, the lower threshold voltage is approximately 1.1 V. In some examples, the lower threshold voltage is selected to help reduce the chances of a short-circuit condition in the stack 104.

In some examples, the lower threshold voltage is a predetermined value stored in memory. In various examples, the cell balancing apparatus 124 receives the lower threshold voltage from a remote client 110, such as a remote user and/or a supervisory control and data acquisition system (“SCADA”).

If the measured voltage measured at step 502 is not less than the lower threshold, the charge and/or discharge cycle continues, and the sensors 114 continue to read data from the cell 102. If the measured voltage is lower than the lower threshold, the method 500 continues to step 506 and determines whether the deviation is greater than a threshold deviation. The deviation is the difference between the measured voltage of step 502 and the lower threshold voltage. In some examples, the method 500 includes calculating the deviation.

In one example, a sensor 114 measures, at step 502, a voltage of 0.02 V across a cell 102. The sensor 114 relays the measured voltage to the cell balancing apparatus 124. In such an example, the cell balancing apparatus 124 then determines, at step 504, that the measured voltage of 0.02 V is less than the lower threshold voltage of 0.05 V. If the difference between the measured voltage and the lower threshold voltage is less than a threshold deviation, no adjustments are made, and the sensor 114 continues to monitor the voltage of the cell 102. In some examples, the threshold deviation is 0.01 V, meaning that the difference between the measured voltage and the lower threshold voltage is greater than the threshold deviation.

The method 500 includes a step 508 of transferring current from an additional cell 102 into the cell 102, if the deviation is greater than the threshold deviation. In some examples, the cell balancing apparatus 124 actuates a circuit component (e.g., a switch 118) to transfer current from another cell 102 in the same stack 104 into the cell 102. In some examples, the additional cell 102 is a cell 102 with a measured voltage greater than the lower threshold voltage and/or greater than the upper threshold voltage. In various examples, the method 500 includes actuating a sensor 114 to measure a voltage of additional cells 102 in response to determining, at step 506, that the deviation is greater than the threshold deviation. In one or more examples, the method 500 includes creating pairs of cells 102 for energy transfer based on measured voltages.

In some examples, the method 500 includes a step, in addition and/or alternative to step 508, of switching a configuration of a connection between cells 102 in response to the deviation being greater than the threshold deviation. For example, the method 500 includes actuating the circuitry (e.g., via a switch 118) to change the connection between cells 102 from a parallel configuration to a series configuration in response to the deviation being greater than a threshold deviation. In one or more examples, the method includes switching a configuration of a connection between stacks 104 and/or strings 106 of cells 102 in response to the deviation being greater than a threshold deviation. In some examples, the method 500 includes switching the configuration of the strings 106 from a parallel configuration to a series configuration. In some examples, the method 500 includes a step of, in response to the deviation being greater than the threshold deviation, decreasing a quantity of strings 106 by increasing the quantity of stacks 104 in each string 106.

In some examples, the method 500 includes returning to step 502 of measuring the voltage, and the sensor 114 continues to monitor the voltage until the cell balancing apparatus 124 determines that the measured voltage is greater than the lower threshold. In some examples, in response to the measured voltage being greater than the lower threshold and/or greater than another threshold value greater than the lower threshold, the cell balancing apparatus 124 actuates the circuitry to cease transferring current from the additional cell 102 into the cell 102.

In some examples, the method 500 includes determining, in response to a measured voltage being greater than a threshold deviation less than the lower threshold voltage, that a short circuit condition or other fault has occurred in the stack 104. In various examples, the method 500 includes taking a corrective action based on detecting the fault. In some examples, the corrective action includes: isolating the stack 104 and/or cell 102 (e.g., using fuses, circuit breakers, and/or other protective devices to interrupt a flow of current to the stack 104 and/or cell 102), transmitting a notification to a remote client 110, transmitting an audible and/or visual notification via an alarm in communication with the processor 116, and/or any combination thereof.

Although FIGS. 4 and 5 illustrate measuring voltage and performing cell balancing based on the measured voltage, examples of the present disclosure are not so limited. Examples of the present disclosure include performing cell balancing using methods that are similar to the methods 400 and 500 but instead use other parameters measured by sensors 114, such as temperature or current, to determine when to initiate a transfer of energy between cells 102. In some examples, current sensors 114 measure charging and/or discharging currents of cells 102. In some examples, the processor 116 is configured to calculate net current flow in and out of a cell 102 based at least in part on the measured currents and actuate cell balancing accordingly.

Referring to FIG. 3, in some examples, a cell balancing system 300 having a multi-layer balancing topology. In some examples, the cell balancing system 300 is configured to balance energy not only between individual cells 102, as described in connection with methods 400 and 500, but also between groups of cells 102.

In some examples, the cell balancing system 300 includes a plurality of cell balancing units 130. In some examples, each cell balancing unit 130 includes at least one of: a sensor 114, a transistor, a resistor, a capacitor, an inductor, a processor, and/or any combination thereof. In some examples, each cell balancing unit 130 is configured to measure data for individual cells 102. In some examples, the cell balancing units 130 compare data from one cell 102 to that of a neighboring cell 102. In some examples, a master cell balancing unit 132 of the cell balancing apparatus 124 is configured to receive data from the individual cell balancing units 130 to balance voltages between groups of cells 102. In some examples, a group of cells 102 is serviced by one cell balancing unit 130.

In some examples, the cell balancing system 300 includes an intermediate energy storage device, such as a supercapacitor and/or an inductor. In various examples, the intermediate energy storage device is configured to store charge to be transferred between cells 102. For example, rather than discharging a cell 102 directly into another cell 102, the intermediate energy storage device is configured to store a charge to be transferred to the receiving cell 102. In other examples, the system 300 is configured to transfer energy directly between cells 102 without intermediate storage.

In some examples, the energy storage system 100 is configured to provide accurate assessments of the state of charge (“SoC”), state of health (“SoH”), and/or state of power (“SoP”) of the energy storage system 100. In some examples, the energy storage system 100 is configured to assess SoC for the energy storage system 100 by assessing SoC for individual cells 102. In some examples, the system 100 is configured to continuously monitor the SoC of an individual cell 102 via sensors 114 during a charge cycle. In various examples, the system 100 adjusts charging rates during a charge cycle.

In some examples, the processor 116 is configured to determine whether a cell 102 has reached a predetermined SoC level for that cell 102. In some examples, the SoC level is determined based on at least one of: input from a remote client 110, an application for the energy storage system 100, SoC levels of neighboring cells 102, and/or any combination thereof. In some examples, the predetermined SoC level is 100% of the cell 102's capacity. In other examples, the predetermined SoC level is lower than 100%, such as approximately 80%. In some examples, in response to the cell 102 reaching the predetermined SoC level, the processor 116 performs at least one of the following: reduces the charging rate of the cell 102, discharges the cell 102 into another cell 102, terminates the charge cycle for that cell 102, isolates the cell 102 from the charging process, or any combination thereof.

In some examples, the processor 116 is configured to actuate adjustments to a charging rate during a charge cycle based on other parameters, such as voltage measurements, current measurements, temperature measurements, and/or any combination thereof. Referring to FIG. 2, in some examples, the energy storage system 100 includes one or more temperature control apparatuses 122. In some examples, the temperature control apparatuses 122 are in communication with the processor 116 and are configured to measure and/or transmit temperature data for one or more cells 102. In some examples, the energy storage system 100 includes a temperature control apparatus 122 for each stack 104 of cells 102.

In some examples, the temperature control apparatus 122 includes a sensor 114. In various examples, the sensor 114 is a temperature sensor configured to provide real-time temperature readings for individual cells 102. In some examples, the temperature control apparatus 122 relays data from the sensor 114 to the processor 116. In some examples, the temperature control apparatus 122 includes a temperature control unit. In some examples, at least one cell 102 is fluidically connected to the temperature control unit. In some examples, the temperature control unit includes cooling and/or heating elements and is configured to cool and/or heat electrolyte that flows in and out of the cells 102. In some examples, the temperature control unit is connected to the processor 116. In some examples, electrolyte from all cells 102 in the module 108 is manifolded together, providing an electrical path that can help with balancing of energy between cells 102.

In various examples, the processor 116 is configured to actuate components of the energy storage system 100 to take actions to help prevent overheating and/or thermal runaway based on data received from the temperature control apparatus 122. In some examples, such actions include adjusting a charge rate for a cell 102, stack 104, string 106, and/or module 108. In some examples, the temperature control apparatus 122 actuates components of the energy storage system 100 to adjust charging rates during a charge cycle. In some examples, the processor 116 receives a temperature measurement for a particular cell 102 and determines that the measured temperature is above a temperature threshold. In some examples, the processor 116 then decreases the charging rate for that cell 102. In some examples, the processor 116 decreases the charging rate by communicating with at least one of: a switch 118, a power supply supplying charge to the cell 102, a cell balancing apparatus 124, and/or any combination thereof.

Referring to FIG. 2, in some examples, the energy storage system 100 includes a power converter 126 and an AC interconnect 128. In some examples, the power converter 126 is configured to convert direct current (“DC”) voltage from the energy storage system 100 to alternating current (“AC”) voltage that may be suitable for a particular application. In some examples, the power converter 126 is part of the module 108. In other examples, the power converter 126 is external to the module 108. In some example, the AC interconnect 128 provides an interface between the energy storage system 100 and a utility grid. In some examples, the AC interconnect is electrically connected to the power converter 126.

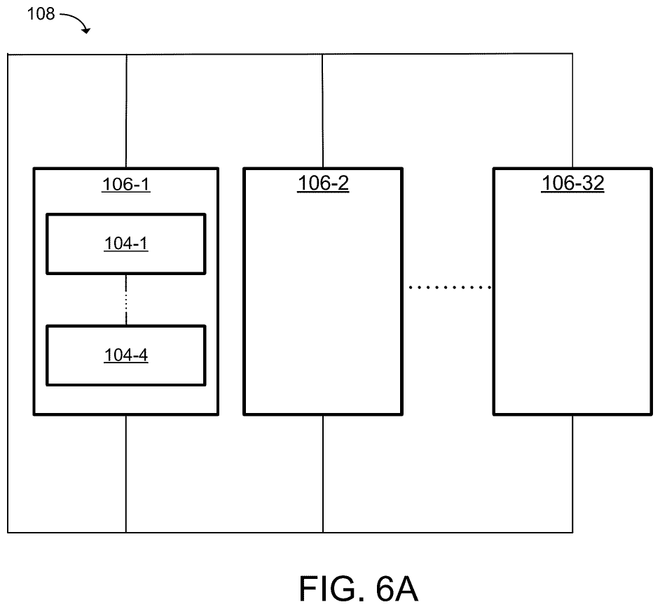

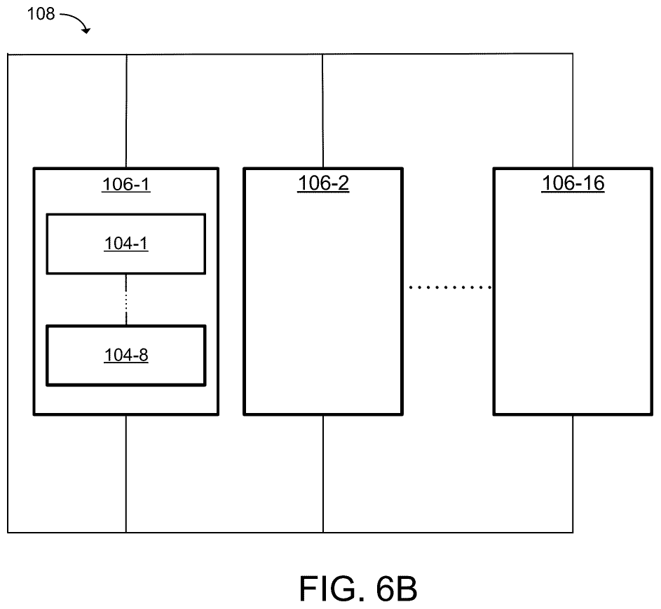

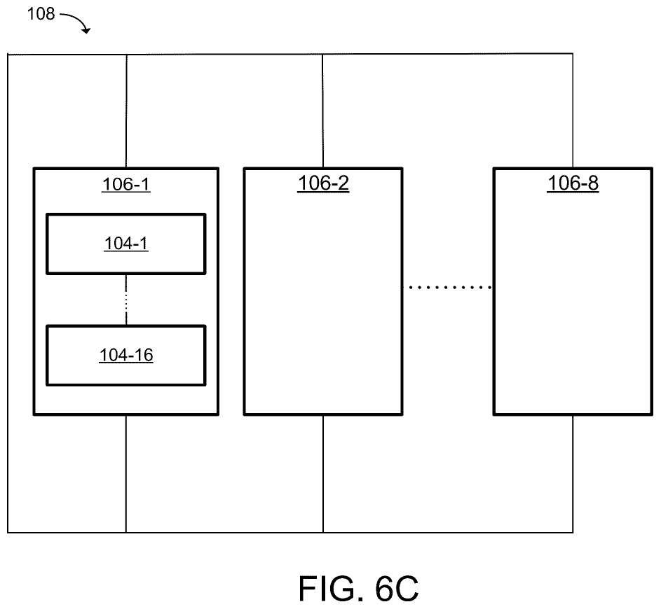

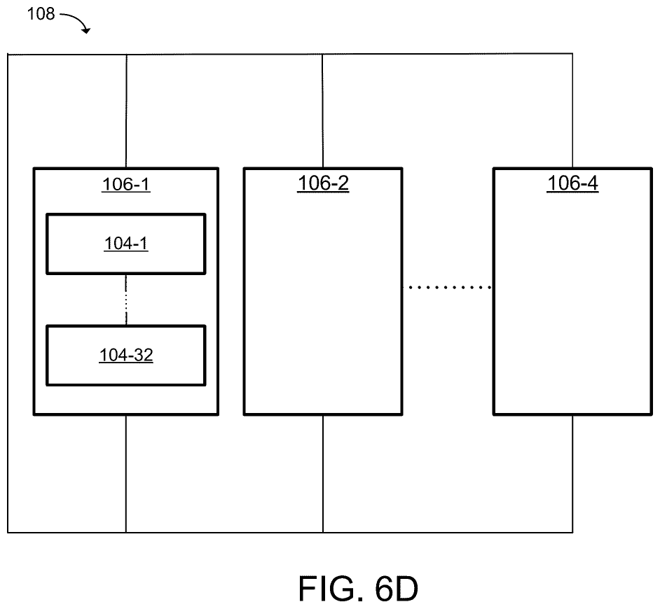

Referring to FIGS. 6A-D, examples of the present disclosure include a method (e.g., method 700) for managing energy for an energy storage device, such as the energy storage system 100. In some examples, methods include keeping a ratio of a module voltage to an application voltage within a particular range. As used herein, “module voltage” refers to a voltage outputted by a module 108 of the energy storage system 100 and inputted to the power converter 126. As such the “module voltage” can also be referred to as an “input voltage.” As used herein, “Application voltage” refers to a voltage to be used for an application, such as a connection to a utility grid and/or a consumer application. The “application voltage” includes a voltage outputted by the power converter 126. As such, “application voltage” can also be referred to as an “output voltage” for the module 108.

In some examples, the power converter 126 is configured to convert between the module voltage and the application voltage. In some examples, keeping the ratio within a particular range can help to improve efficiency of the power conversion. In some examples, the range is between and inclusive of 0.1 and 10.0. In some examples, the ratio is greater than 10.0. In some examples, the ratio is between and inclusive of 0.7 and 1.3. Examples of the present disclosure include changing a configuration of the strings 106, stacks 104, and/or cells 102 of the module 108 to keep or bring the ratio back into the predetermined range. In some examples, changing the configuration comprises changing a connection type (e.g., series or parallel) between strings 106, stacks 104, and/or cells 102 of the module 108, changing a quantity of strings 106 in a module 108, changing a quantity of stacks 104 in a string 106, changing a quantity of cells 102 in a stack 104, and/or any combination thereof. In some examples, changing the configuration includes changing a quantity of strings 106 in a module 108 without changing a total quantity of cells 102 in the module 108.

Examples of the present disclosure include a method (e.g., method 800) of managing energy for an energy storage system 100 while discharging cells 102 of the energy storage system 100. In one example, the application voltage is 480 V. The energy storage system 100 includes a stack 104 of 100 charged cells 102. The energy storage system 100 is configured to discharge cells 102 in the energy storage module 108 during a discharge cycle. In some examples, the energy storage system 100 is configured to decrease a quantity of strings 106 by increasing a quantity of stacks 104 in a particular string 106 and/or in each string 106. In some examples, the processor 116 determines to increase the quantity of strings 106 based at least in part on one or more measured parameters. The measured parameters include, in some examples, a parameter measured by a sensor 114. In some examples, the parameter is a voltage across a cell 102. In some examples, the parameter is an average of voltages measured across multiple different cells 102 of the system 100. In some examples, the processor 116 determines to make a change to the configuration of the module 108 in response to a comparison of the average voltage and/or measured voltage to a pre-determined voltage value.

Referring to FIG. 6A, in some examples, at an initial time of the discharge cycle, a module 108 includes 32 strings 106-1, . . . 106-32 connected in parallel. Each string 106-1, . . . , 106-32 includes 4 stacks 104-1, . . . , 104-4 connected in series within the string 106-1, . . . , 106-32. At the initial time, the voltage across a cell 102 1.6 V, and the stack 104 includes 100 cells. In such examples, the voltage of the stack is 160 V. Because there are 4 stacks 104-1, . . . , 104-4 in each string 106, the voltage across each string 106-1, . . . , 106-32 and, respectively, of the module 108, is 640 V. In such examples, the ratio of the module voltage to the application voltage is 1.3, which is within a predetermined range for the ratio.

In some examples, as the module 108 is being discharged, the voltage across the cells 102 drops, and a sensor 114 reads a cell 102 voltage of 0.8 V, dropping the ratio to 0.7. In some examples, the sensor 114 reads the cell 102 voltage from the same cell 102 as the previous measurement. In other examples, the sensor 114 measures the cell 102 voltage from a different cell 102 in the module 108. In some examples, the sensor 114 relays the voltage measurement to the processor 116. In some examples, the processor 116 determines, based at least in part on the received voltage measurement, to change a quantity of the strings 106 in the module 108. In some examples, the processor 116 determines that the voltage is below a threshold voltage and, in response, actuates circuitry to decrease the quantity of strings 106. Referring to FIG. 6B, in some examples, the processor 116 actuates the circuitry to decrease the quantity of strings 106 such that the module 108 includes 16 strings 106-1, . . . , 106-16 connected in parallel, with 8 stacks 104-1, . . . , 104-8 per string 106-1, . . . , 106-16. In such examples, decreasing the quantity of strings 106 increases the module voltage to application voltage ratio back up to 1.3. In some examples, the discharge cycle continues.

In some examples, a measured voltage across a cell 102 reaches 0.4 V or lower. In response, the processor 116 determines to further decrease the quantity of strings 106. Referring to FIG. 6C, in some examples, the processor 116 determines to change the configurations such that the module 108 includes 8 strings 106-1, . . . , 106-8 connected in parallel. In some examples, each string 106-1, . . . , 106-8 includes 16 stacks 104-1, . . . , 104-16 connected in series. In such examples, the change in configuration increases the ratio back up to 1.3.

In some examples, during the discharge cycle, a voltage sensor 114 measures a voltage of 0.2 V across a cell 102. In response, the processor 116 determines to further decrease the quantity of strings 106-1, . . . , 106-8. Referring to FIG. 6D, in some examples, the processor 116 actuates components of the energy storage system 100 such that the module 108 includes 4 strings 106-1, . . . , 106-4. In some examples, each string 106-1, . . . , 106-4 includes 32 stacks 104-1, . . . , 104-32 connected in series. In some examples, the discharge cycle continues until the module 108 reaches an empty storage state, or the bottom of the discharge cycle. In some examples, the processor 116 determines to terminate the discharge cycle in response to the measured voltage being less than a discharge threshold. In some examples, the discharge threshold is a voltage of approximately 0.1 V per cell 102.

In some examples, the processor 116 is configured to determine threshold cell 102 voltages (e.g., 0.8 V, 0.4 V, and 0.2 V) for changing a quantity of the strings 106 based at least in part on the application voltage and a predetermined range of the ratio between the module voltage and the application voltage. In some examples, changing the quantity of strings 106 includes halving the quantity of strings 106. In some examples, increasing the quantity of stacks 104 per string 106 includes doubling the quantity of stacks 104 in each string 106.

In some examples, changing a quantity of strings 106 includes creating one or more new strings 106 and/or consolidating strings 106. For example, as shown in FIGS. 6A-D, decreasing a quantity of strings 106 includes reconfiguring all of the stacks 104 from at least one string 106 such that the stacks 104 are re-assigned to different strings 106 and connected in series with the stacks 104 of the string 106 to which they are re-assigned. In some examples, increasing a quantity of strings includes creating a new string by connecting stacks 104 already present in the module 108. In some examples, the energy storage system 100 includes a switch 118 (e.g., a switching relay and/or relay switch) configured to perform the reconfiguration. Referring to FIG. 2, in some examples, the switch 118 is part of a distribution component 120 of the energy storage system 100. In some examples, the distribution component 120 includes a distribution network, a bus bar, and/or any combination thereof. In some examples, the distribution component 120 controls connections between cells 102, stacks 104, and/or strings 106 of the module 108.

In some examples, the processor 116 actuates the switching relay to perform the reconfiguration. In various examples, the switching relay includes at least one of: a mechanical relay, a vacuum relay, a solid-state relay, and/or any combination thereof. In some examples, the switching relay controls a connection between two or more strings 106 of the module 108, a connection between two or more stacks 104 of the module 108, or any combination thereof. In some examples, the switching relay is configured to control a connection between two stacks 104 of different strings 106. In some examples, the processor 116 is configured to actuate multiple switches 118 to change a configuration of the module 108.

In some examples, the processor 116 is further configured to change a configuration of a connection between stacks 104 in a string 106. In some examples, the processor 116 determines whether stacks 104 in a string 106 are to be connected in parallel or in series. In some examples, the processor 116 determines a configuration for the stack 104 connections based at least in part on a range for a ratio of the module voltage to the application voltage and using measurements from sensors 114, in a similar manner to that described above in connection to FIGS. 6A-D.

Examples of the present disclosure include methods (e.g., method 700) for managing energy for the energy storage system 100 during a charge cycle of the energy storage system. In some examples, such a method involves increasing a quantity of strings 106 by decreasing a quantity of stacks 104 of at least one string 106. In some examples, a method for managing energy during the charge cycle is a reverse order of the method illustrated in FIGS. 6A-D, with the quantity of strings 106 connected in parallel increasing as the SoC increases and/or as the voltage across each cell 102 increases. In some examples, the processor 116 determines to increase the quantity of strings 106 in response to measured voltages for the cells 102 surpassing increasing voltage thresholds throughout the charge cycle, with each of the voltage thresholds representing less than 100% of the maximum SoC for that cell 102.

In some examples, one or more stacks 104 of a string 106 are connected in a parallel configuration. In response to determining that the module voltage is below a particular threshold, the processor 116 determines to change connections between stacks 104 such that all stacks 104 in the string 106 are connected in series, as shown in FIG. 2. In some examples, the processor 116 determines to increase a percentage of stacks 104 connected in series.

In some examples, the processor 116 determines that the module voltage is greater than or equal to a particular module voltage threshold. In some examples, the processor 116 determines that the module 108 is fully charged (e.g., has reached 100% SoC). In some examples, in response, the processor 116 terminates the charge cycle. In some examples, in response, the processor 116 determines to increase a percentage of stacks 104 connected in parallel. In some examples, increasing the percentage of stacks 104 connected in parallel includes connecting all of the stacks 104 in parallel.

Examples of the present disclosure include increasing a quantity of stacks 104 connected in parallel during a charge cycle based on voltages across cells 102 surpassing voltage thresholds. In some examples, the stacks 104 are all connected in series at a starting time of the charge cycle or baseline SoC. As the module 108 charges, the processor 116 actuates components of the energy storage system 100 to increase a percentage of stacks 104 connected in parallel.

In some examples, the processor 116 is configured to communicate with a remote client 110 over a network 112. In some examples, the network 112 includes a controller area network (“CAN”), Ethernet connection, the Internet, a local area network, a wide area network, a wireless network, or any combination thereof. In some examples, the processor 116 is connected to a number of remote clients 110. In some examples, remote clients 110 include client devices. Client devices include, for example, computing devices such as mobile communication devices and personal computers. In some examples, energy storage system 100 also includes applications accessed via the client devices. In some examples, the functions described herein as being performed by the processor 116 are, in some additional or alternative examples, performed by another processor communicatively connected to the processor 116 via the network 112, such as the remote server, a client device, and/or any combination thereof. Each of the functions described herein as being performed by the processor 116 through communication between the processor 116 and other components of the energy storage system 100 may also be performed by a remote processor through communication between the remote processor and that component of the energy storage system 100 and/or the processor 116.

In some examples, the remote client 110 includes a SCADA. In some examples, the energy storage system 100 includes a communications interface between the energy storage system 100 and an external system. In some examples, the energy storage system 100 includes an interface between the system 100 and a SCADA. In some examples, the energy storage system 100 is configured to exchange data with a remote client 110 in real time. Such data includes, in some examples, at least one of: current measurements, cell 102 status, voltage measurements, sensor 114 data, temperature, SoC, module voltage to application voltage ratios, and/or any combination thereof. In some examples, the processor 116 is configured to generate status reports for the energy storage system 100 and transmit such reports to the remote client 110.

In some examples, the processor 116 transmits measurements from the sensors 114 to the SCADA. In some examples, the processor 116 receives an application voltage from the SCADA and calculates a ratio of module voltage to application voltage accordingly. In various examples, the processor 116 then determines to make changes to a configuration of the module 108 based on the ratio.

In some examples, the processor 116 determines to make changes to a configuration of a module 108. In some examples, the processor 116 is configured to make changes to the configuration based at least in part on input from a user and/or input received from a remote client 110.

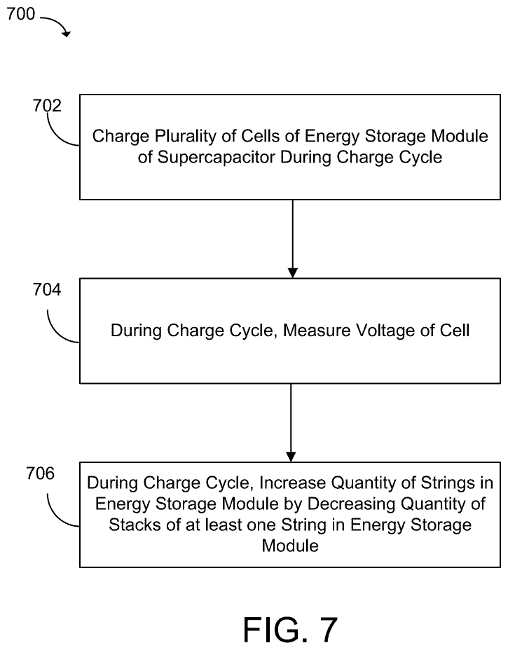

Referring to FIG. 7, a method 700 of managing energy for an energy storage system 100 includes a step 702 of charging a plurality of cells 102 of an energy storage module 108 of an energy storage device 100 during a charge cycle, such as the energy storage system 100. The method 700 includes a step 704 of, during the charge cycle, measuring a voltage of a cell 102 of the plurality of cells 102. In some examples, the method 700 includes a step 706 of, during the charge cycle, and based at least in part on the measured voltage, increasing a quantity of the plurality of strings 106 by decreasing a quantity of the plurality of stack 104s of at least one string of the plurality of strings 106.

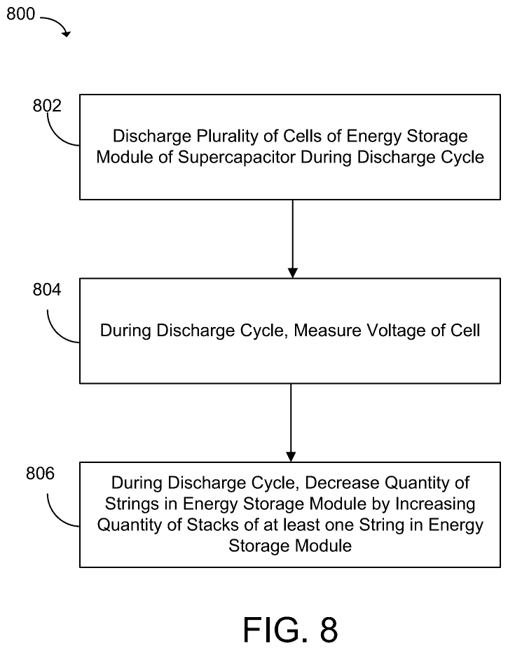

Referring to FIG. 8, a method 800 of managing energy for an energy storage system 100 includes a step 802 of discharging a plurality of cells 102 of an energy storage module 108 of an energy storage device during a discharge cycle, such as the energy storage system 100. The method 800 includes a step 804 of, during the discharge cycle, measuring a voltage of a cell 102 of the plurality of cells 102. In some examples, the method 800 includes a step 806 of, during the discharge cycle, and based at least in part on the measured voltage, decreasing a quantity of the plurality of strings 106 by increasing a quantity of the plurality of stack 104s of at least one string of the plurality of strings 106.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein, a plurality of particular features does not necessarily mean every particular feature of an entire set or class of the particular features.

The term “about” or “substantially” or “approximately” in some embodiments, is defined to mean within +/−5% of a given value, however in additional embodiments any disclosure of “about” or “substantially” or “approximately” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the operations described in this specification may be implemented as a hardware circuit comprising custom very large scale integrated (“VLSI”) circuits or gate arrays, off-the-shelf semiconductors such as logic chips, transistors, or other discrete components. Operations may also be implemented in programmable hardware devices such as a field programmable gate array (“FPGA”), programmable array logic, programmable logic devices or the like.

Operations described herein may also be implemented in code and/or software for execution by various types of processors. Code may, for instance, comprise one or more physical or logical blocks of executable code which may, for instance, be organized as an object, procedure, or function. Nevertheless, the executables of identified code need not be physically located together, but may comprise disparate instructions stored in different locations which, when joined logically together, comprise the code and achieve the stated purpose for the module.

Indeed, an operation implemented in code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different computer readable storage devices. Where operations or portions of an operation are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

In the preceding description, numerous specific details are provided, such as examples of programming, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described above with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Examples of the present disclosure include one or more elements communicatively coupled via a wireless connection. The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

What is claimed is:

1. A method of managing energy for a supercapacitor, comprising:
charging a plurality of cells of an energy storage module of a supercapacitor during a charge cycle, wherein:
the energy storage module comprises a plurality of strings connected to each other in a parallel configuration;
each string of the plurality of strings comprises a plurality of stacks connected to each other in a series configuration; and
each stack of the plurality of stacks comprises a quantity of cells of the plurality of cells;
during the charge cycle, measuring a voltage of a cell of the plurality of cells; and
during the charge cycle, and based at least in part on the measured voltage, increasing a quantity of the plurality of strings by decreasing a quantity of the stacks of at least one string of the plurality of strings.

2. The method of claim 1, further comprising transmitting the measured voltage to a supervisory control and data acquisition system, wherein increasing the quantity of the plurality of strings is further based at least in part on input received from the supervisory control and data acquisition system.

3. The method of claim 1, wherein increasing the quantity of the plurality of strings comprises creating one or more new strings by reconfiguring at least one stack of the plurality of stacks from each string into the one or more new strings.

4. The method of claim 1, wherein:
the voltage comprises a first measured voltage; and
the method further comprises, during the charge cycle:
measuring a second measured voltage, the second measured voltage comprising a voltage of the cell, a voltage of an additional cell of the plurality of cells, or a combination thereof; and
based at least in part on the second measured voltage, further increasing the quantity of the plurality of strings by further decreasing the quantity of the plurality of stacks of at least one string of the plurality of strings.

5. The method of claim 4, further comprising:
during the charge cycle, measuring a third measured voltage, the third measured voltage comprising an additional voltage of the cell or of an additional cell of the plurality of cells; and
determining whether the third measured voltage is greater than or equal to a threshold voltage; and
in response to determining that the third measured voltage is greater than or equal to the threshold voltage, terminating the charge cycle.

6. The method of claim 5, wherein the threshold voltage is greater than the second measured voltage, and the second measured voltage is greater than the first measured voltage.

7. The method of claim 1, wherein increasing the quantity of the plurality of strings based at least in part on the measured voltage comprises increasing the quantity of the plurality of strings in response to determining that the measured voltage is greater than a pre-determined voltage.

8. The method of claim 1, further comprising:
determining, based at least in part on the measured voltage, an input voltage of the energy storage module; and
determining, based at least in part on the input voltage of the energy storage module, a ratio between the input voltage and an output voltage of the energy storage module,
wherein increasing the quantity of the plurality of strings is further based at least in part on whether the ratio is outside of a range.

9. The method of claim 8, wherein the quantity of the plurality of strings is increased in response to the ratio being outside of the range.

10. The method of claim 9, wherein the range is between, and inclusive of, 0.1 and 10.0.

11. The method of claim 1, wherein:
the cell of the plurality of cells comprises a first cell; and
the method further comprises:
determining whether the measured voltage is at least one of greater than an upper threshold voltage or less than a lower threshold voltage;
in response to determining that the measured voltage is at least one of greater than the upper threshold voltage or less than the lower threshold voltage, calculating a deviation between the measured voltage and at least one of the upper threshold voltage or the lower threshold voltage;
determining whether the deviation is greater than a threshold deviation; and
in response to determining that the deviation is greater than the threshold deviation, actuating a circuit to perform at least one of the following:
a transfer of current from the first cell to a second cell of the plurality of cells in response to the measured voltage being greater than the upper threshold voltage; and
a transfer of current from the second cell to the first cell in response to the measured voltage being less than the lower threshold voltage.

12. The method of claim 11, wherein the upper threshold voltage is not less than 1.2 Volts (“V”) and not greater than 3 V.

13. The method of claim 11, wherein the lower threshold voltage is not less than 0.05 Volts (“V”) and not greater than 1.2 V.

14. The method of claim 1, wherein increasing the quantity the plurality of strings comprises maintaining a quantity of the plurality of cells in the energy storage module.

15. A supercapacitor, comprising:
an energy storage module comprising a plurality of strings connected to each other in a parallel configuration and a plurality of cells, wherein:
each string of the plurality of strings comprises a plurality of stacks connected to each other in a series configuration; and
each stack of the plurality of stacks comprises a quantity of cells of the plurality of cells;
a circuit configured to charge the plurality of cells during a charge cycle;
a voltage sensor configured to measure a voltage of a cell of the plurality of cells during the charge cycle;
a switch; and
a processor configured to, during the charge cycle and based at least in part on the measured voltage, actuate the switch to increase a quantity of the plurality of strings of the parallel configuration by decreasing a quantity of the plurality of stacks of at least one string of the plurality of strings.

16. The supercapacitor of claim 15, wherein the switch comprises a relay switch configured to control a connection between a first string of the plurality of strings and a second string of the plurality of strings.

17. The supercapacitor of claim 16, wherein the relay switch comprises a first relay switch and the supercapacitor further comprises a second relay switch configured to control a connection between a first-string stack of the first string and a second-string stack of the second string.

18. A method of managing energy for a supercapacitor, comprising:
discharging a plurality of cells of an energy storage module of a supercapacitor during a discharge cycle, wherein:
the energy storage module comprises a plurality of strings connected to each other in a parallel configuration;
each string of the plurality of strings comprises a plurality of stacks connected to each other in a series configuration; and
each stack of the plurality of stacks comprises a quantity of cells of the plurality of cells;
during the discharge cycle, measuring a voltage of a cell of the plurality of cells; and
during the discharge cycle, and based at least in part on the measured voltage, decreasing a quantity of the plurality of strings by increasing a quantity of the plurality of stacks of at least one string of the plurality of strings.

19. The method of claim 18, wherein:
the voltage comprises a first measured voltage; and
the method further comprises, during the discharge cycle:
measuring a second measured voltage of the cell or of an additional cell of the plurality of cells;
determining whether the second measured voltage is less than or equal to a threshold voltage; and
in response to determining that the second measured voltage is less than or equal to the threshold voltage, terminating the discharge cycle.

20. The method of claim 18, wherein decreasing the quantity of the plurality of strings comprises halving the quantity of the plurality of strings and increasing the quantity of the plurality of stacks of each string of the plurality of strings comprises doubling the quantity of the plurality of stacks.
